(19) United States
(12) Patent Application Publication
(10) Pub. No.: US 2004/0250149 A1
(43) Pub. Date: Dec. 9, 2004

(54) Safe power-off system and method thereof

(76) Inventors: Chih-Ming Tsai, Taipei Hsien (TW); Keh-Jun Tsai, Taipei City (TW)

Correspondence Address: KNOBBE MARTENS OLSON & BEAR LLP, 2040 MAIN STREET, FOURTEENTH FLOOR, IRVINE, CA, 92614, US

(21) Appl. No.: 10/781,117

(22) Filed: Feb. 18, 2004

(30) Foreign Application Priority Data
Jun. 3, 2003 (TW) 92115141

(51) Int. Cl. G06F 1/26

(52) U.S. Cl. 713/330

(57) ABSTRACT

The present invention provides a safe power-off system and method thereof used for an electrical system. When a user pushes a power-off button of the electrical system, the safe power-off system will receive a power-off signal generated by the power supply apparatus and therefore generate a corresponding interrupt signal to the main system to perform a preparation program having a system power-off preparation procedure. After the main system has completed the power-off preparation procedure, it will acknowledge the safe power-off apparatus that the power can be cut off and subsequently proceeds to cut off the power connection between the system and the power supply apparatus.

### FIELD OF THE INVENTION

The present invention relates to a safe power-off system and method thereof, particularly to one that allows a computer system to shut down before the power supply is cut.

### BACKGROUND OF THE INVENTION

The use of computers at this day and age has become more diversified and data processing has become increasingly complex. The frequency and effect of interruptions caused by the computer power source can be damaging especially when the situation leads to substantial amount of data loss. As an example, a user who is creating a file or performing data calculation is likely to lose the data if he or she accidentally pushes the power on/off button which consequently disrupts the power supply.

Computers in general are provided with a permanent storage such as, a floppy disk drive, a compact disc-read only memory (CD-ROM) drive, a disk drive connected to the Internet, and with quantities of intermediate or buffer storage, all interfacing with the user mostly through a display. As work is in process, materials are moved from one location to another under the user's direction through an operating system in the computer.

In the event of power interruption, the portion of the work in process that has not been placed in the permanent storage will likely to be lost. As a result, the user will need to recreate the file or perform the data calculation again in order to recuperate the lost data.

### SUMMARY OF THE INVENTION

It is an object of the present invention to provide a safe power-off system in an electrical system. The safe power-off system seeks to preserve the data in the auxiliary memory device when power supply is interrupted during data operation.

It is also an object of the present invention to provide a safe power-off method in an electrical system. The safe power-off method first performs a preparation program when a user turns the power off during data operation. The preparation program will allow the data to be preserved and consequently stored in the auxiliary memory device.

It is another object of the present invention to provide a safe power-off method in an electrical system. The safe power-off method seeks to maintain the power supply from the power supply apparatus to the electrical system for a pre-set time when a user turns the power off during data operation. This will ensure that the data is not lost but placed the permanent storage.

Accordingly, there is provided a safe power-off system and method thereof in an electrical system, such as a computer system. When a user pushes the power-off button, the safe power-off system will receive a power-off signal generated by the power supply apparatus to generate a corresponding interrupt signal to the main system, such as a CPU, of the electric system to perform a preparation program. After the main system has completed the preparation program, it will acknowledge the safe power-off system that the power can be cut off and subsequently proceeds to cut off the connection between the system and the power supply apparatus.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below serve to exemplify the principles of this invention.

FIG. 1A is a block diagram illustrating the operational relationship among the safe power-off system, a power supply apparatus and a main system in an electrical system;

FIG. 1B is a block diagram illustrating the safe power-off system of the FIG. 1A;

FIG. 2 is a flow chart of the safe power-off method in accordance with the first preferred embodiment of the present invention;

FIG. 3 is a flow chart of the safe power-off method in accordance with the second preferred embodiment of the present invention; and

FIG. 4 is a flow chart of the safe power-off method in accordance with the third preferred embodiment of the present invention.

### DETAILED DESCRIPTION OF THE PREFERRED EMBODIMENT

Without limiting the spirit and scope of the present invention, the safe power-off system and method thereof will be illustrated with preferred embodiments. An ordinary person skilled in the art, upon acknowledging these embodiments, can apply the safe power-off system and method thereof to various electrical systems, e.g. a personal computer or industrial computer.

The safe power-off system and method thereof seeks to first stabilize and preserve the data in the memory device before power is eventually turned off during data operation. In the event of power interruption, the portion of work in process will be saved in the permanent storage. The application of the present invention is not limited by the preferred embodiments described in the following.

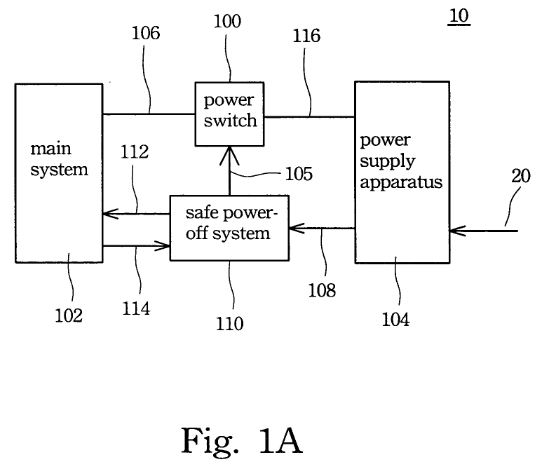

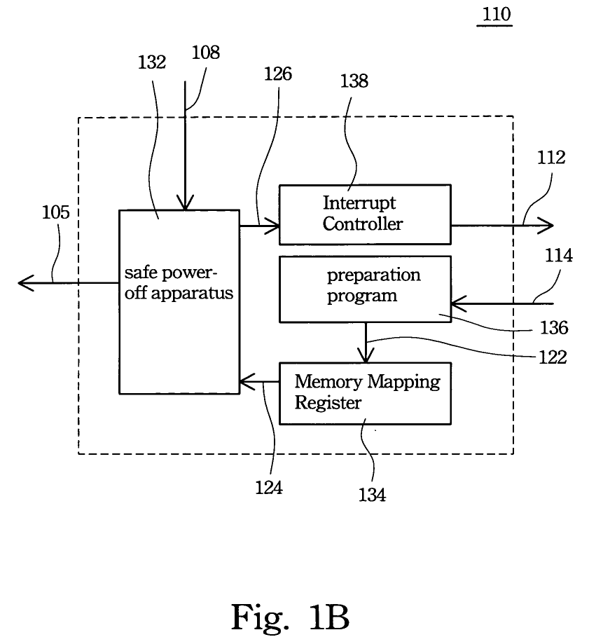

FIG. 1A is a block diagram illustrating the operational relationship among the safe power-off system 110, a power supply apparatus 104 and a main system 102, such as a CPU, in an electrical system 10, such as a computer system. Power is supplied to the main system 102 by the power supply apparatus 104. A power switch 100 is used to connect the main system 102 and the power supply apparatus 104 through two power lines 106 and 116. The power switch 100 controls the connection between the main system 102 and the power supply apparatus 104. The safe power-off system 110 controls the power switch 100 and cuts off the connection according to the main system 102 whether or not the preparation program is completed.

FIG. 1B is a block diagram illustrating the safe power-off system of FIG. 1A. Referring to FIGS. 1A and 1B, the safe power-off system of the present invention comprises an interrupt controller 138 for generating an interrupt signal 112 to the main system 102 before the electrical system 10 turns the power off; a preparation program 136 to be performed by the main system 102 before the electrical system 10 turns the power off; a memory mapping register 134 for storing a cut-off signal 122 which is generated when performing the preparation program; and a safe power-off apparatus for controlling the power switch 100 to cut off the connection between the main system 102 and the power supply apparatus 104. The above preparation program 136 further comprises a procedure to determine whether the main system 102 has completed the preparation procedure before the electrical system 10 turns the power off.

According to the preferred embodiment described in FIGS. 1A and 1B, when a user pushes the on/off power button (20) of the electrical system 10, the power supply apparatus 104 will generate a power-off signal 108 to the safe power-off apparatus 132 of the safe power-off system 110. When the safe power-off apparatus 132 receives the power-off signal 108, it will generate a control signal 126 to the interrupt controller 138. The interrupt controller 138 will then generate a corresponding interrupt signal 112 to the main system 102 (such as a CPU). The interrupt signal 112 can indicate to the main system 102 to get an interrupt vector and to perform a preparation program 136 according to the address indicated by the interrupt vector. The preparation program 136 is an interrupt service routine which comprises a procedure that should be performed before turning the power off. For example, the preparation procedure can back up the proceeding data to the memory device, such as a floppy disc drive, a hard disc drive, a compact disc-read only memory (CD-ROM) drive or a diskette drive connected to the Interne. The preparation procedure can also end the operation system or cut off the connection between the main system 102 and other subsystem.

After the main system 102 has completed the preparation procedure, the preparation program 136 will check whether or not the main system 102 has transmitted back a power-off signal 114. If the power-off signal 114 has been transmitted, the preparation program 136 will write a register signal 122 to the memory mapping register 134 of the safe power-off system 134. Once the register signal 122 is written into the memory mapping register 134, a triggering signal 124 will be generated to trigger the safe power-off apparatus 132 to generate a cut-off signal 105. The cut-off signal 105 will control the power switch 100 to cut off the connection between the main system 102 and the power supply apparatus 104.

According to the safe power-off system 110 of the present invention, even though the user turns off the power of the electrical system 10 during operation, the power supply apparatus 104 will ensure that power supply to the main system 102 is maintained so that to prevent data loss. As such, the safe power-off system 110 still commands the power supply apparatus 104 to continue supplying power to the main system 10 after it receives the power-off signal 108.

The safe power-off system 110 forces the main system 102 to perform and complete a preparation program after it receives the power-off requirement. Once the main system 102 completes the preparation program, the safe power-off system will cut off the connection between the main system 102 and the power supply apparatus. This feature avoids proceeding data loss due to sudden system shutdown.

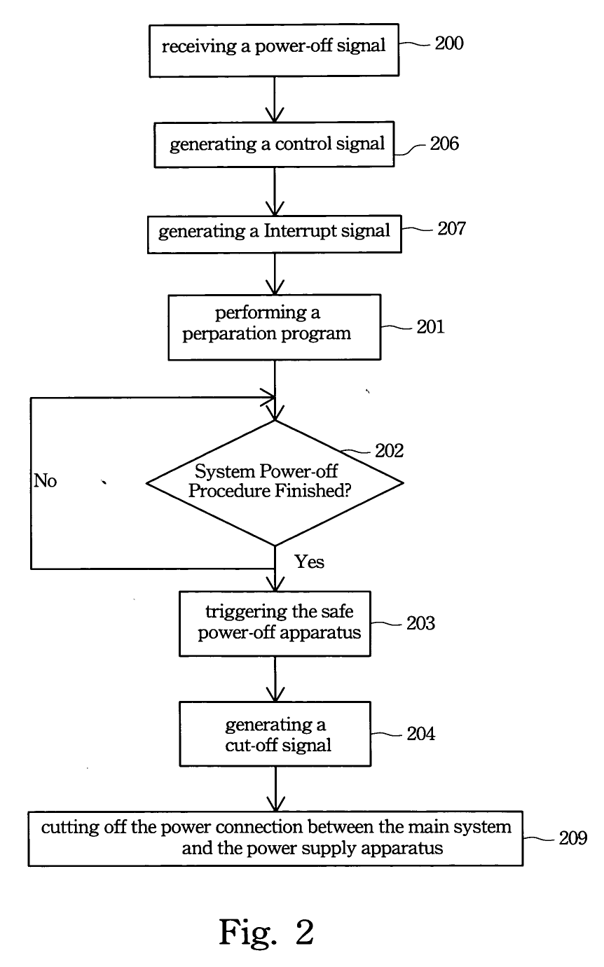

FIG. 2 is a flow chart of the safe power-off method in accordance with the first preferred embodiment of the present invention. In the first step (200), when a user pushes the on/off power button 20, the power supply apparatus 104 will generate a power-off signal 108 to the safe power off apparatus 132 of the safe power-off system 110. In the next step (206), after the safe power-off apparatus 132 receives the power-off signal 108, it will generate a control signal 126 to an interrupt controller 138. The following step (207) shows that the interrupt controller 138 will generate an interrupt signal 112 to the main system 102, such as a CPU. Then, in the following step, the main system 102 will get an interrupt vector in accordance with the interrupt signal 112. The interrupt vector can indicate to the main system 102 to perform a preparation program 136 according to the address indicated by the interrupt vector. The preparation program 136 is an interrupt service routine which comprises a system power-off operation that should be performed before turning the power off to store the proceeding data in a permanent memory device. The different systems have different preparation programs. In step 202, the safe power-off system 110 can determine whether or not the main system has completed the system power-off procedure according to the predetermined procedure in the preparation program. The preparation program 136 can check whether or not the main system 102 has transmitted back a turning power off signal 114. If the main system 102 has not transmitted back a turning power off signal 114, the preparation program 136 will not stop the power-off procedure. In this situation, the power switch 100 will maintain the connection between the main system 102 and the power supply apparatus 104 until the main system 102 transmits back the turning power off signal 114.

In step 203, after the main system 102 has completed all the preparation procedure 136, the preparation program 136 will write a register signal 122 to the memory mapping register 134 of the safe power-off system 134. Once the register signal 122 is written into the memory mapping register 134, the register signal 122 will change the electrical potential of the special pin number of the memory mapping register 134 to generate a triggering signal 124. The triggering signal 124 can acknowledge the safe power-off apparatus 132 to perform a shutdown procedure. In step 204, first the safe power-off apparatus 132 generates a cut-off signal 105 to acknowledge the power switch 100. Finally, in step 209, the power switch 100 can cut off the power connection between the main system 102 and the power supply apparatus 104.

The safe power-off system of the present invention can adopt another design which uses a timer procedure and a predetermined procedure in the preparation program. In this embodiment, the power supply apparatus 104 maintains the power supply to the main system 102 for a definite time that is preset by the user after the on/off power button 20 is pushed.

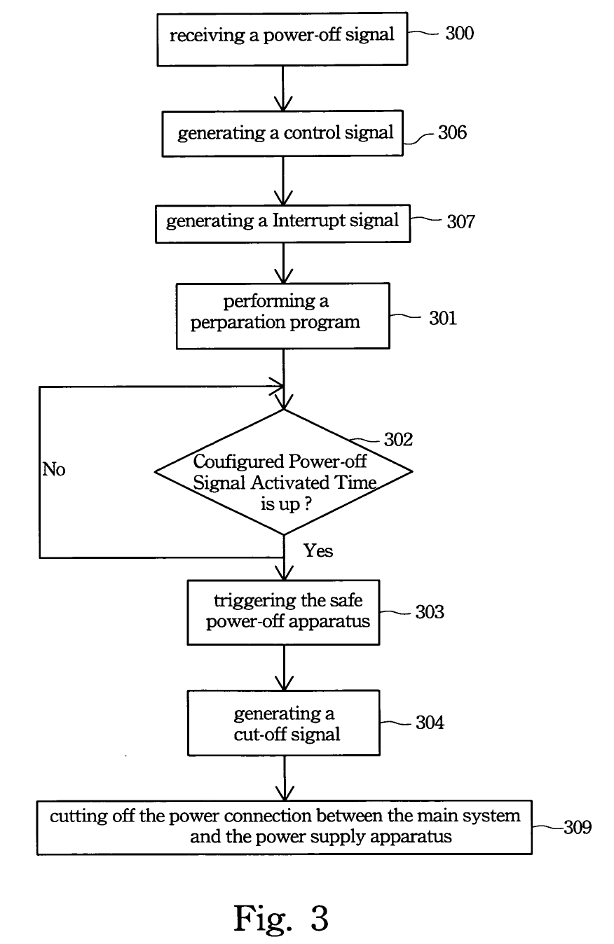

FIG. 3 is a flow chart of the safe power-off method in accordance with the second preferred embodiment of the present invention. In the first step (300), when the user pushes down the power on/off button 20, the power supply apparatus 104 will generate a power-off signal 108 to the safe power off apparatus 132 of the safe power-off system 110. In the next step (306), after the safe power-off apparatus 132 receives the power-off signal 108, it will generate a control signal 126 to an interrupt controller 138. In the following step (307), the interrupt controller 138 will generate an interrupt signal 112 to the main system 102, such as a CPU. Then, in following step (301), the main system 102 will get an interrupt vector in accordance with the interrupt signal 112. The interrupt vector can indicate to the main system 102 to perform a preparation program 136 according the address indicated by the interrupt vector. The preparation program 136 comprises a timer procedure to count the main system 102 to perform the preparation procedure time. In the following step 302, the determination procedure in the preparation program 136 can check whether or not the counted time has reached the set time. Once the set time is reached, the next step will be performed whether or not the preparation program has been completed. If the set time has not been reached, the safe power-off apparatus 132 will control the power switch 100 to maintain the connection between the main system 102 and the power supply apparatus 104.

In the following step 303, when the set time has been reached, the preparation program 136 will write a register signal 122 to the memory mapping register 134 of the safe power-off system 134. Once the register signal 122 is written into the memory mapping register 134, the register signal 122 will change the electrical potential of the special pin number of the memory mapping register 134 to generate a triggering signal 124. The triggering signal 124 can acknowledge the safe power-off apparatus 132 to perform a shutdown procedure. In the following step (304), the safe power-off apparatus 132 will first generate a cut-off signal 105 to acknowledge the power switch 100. In the final step 309, the power switch 100 can cut off the power connection between the main system 102 and the power supply apparatus 104.

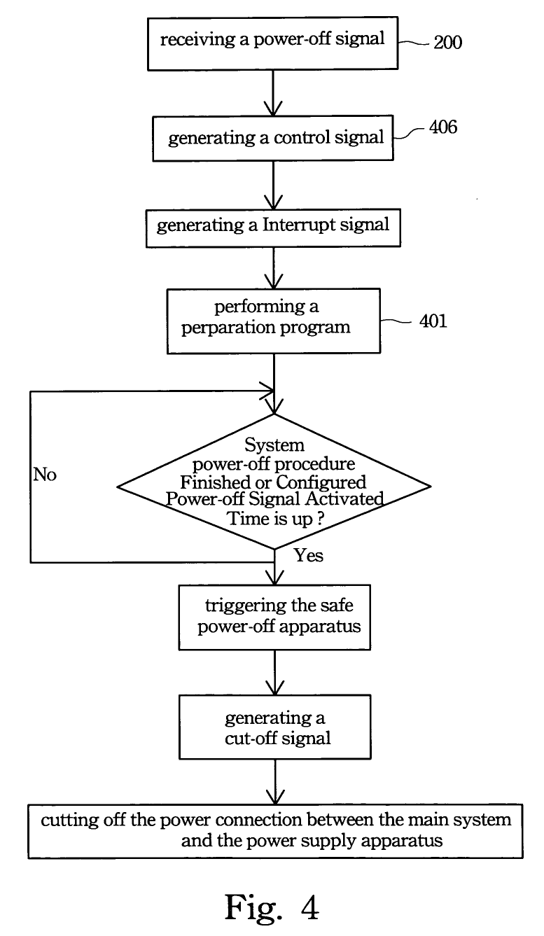

The safe power-off method can also operate based on the combination of the first and second preferred embodiments previously mentioned. FIG. 4 is a flow chart of the safe power-off method in accordance with the third preferred embodiment of the present invention. The third embodiment combines the first and second preferred embodiments to shutdown the main system. It is to be noted, however, other means of combining the first and second preferred embodiments can also be used in the present invention. The main different point in the third embodiment is step 401. In step 401, the preparation program comprises a timer procedure, a determination procedure of the timer procedure, a system power-off operation and a determination procedure of the system power-off operation. According to the third embodiment, the safe power-off system can perform the system power-off procedure and check whether or not the set shutdown time has been reached. When the set shutdown time has been reached, this main system will be forced to turn power off even when the system power-off operation has not been completed. This method therefore avoids a dead lock situation.

This safe power-off system and method stabilize and preserve the data in the memory device before a user of the electrical system turns the power off during operation. In the event of power interruption, the portion of the work in process can still be placed in the permanent storage. As such, even when a user turns the power off during operation, the power supply apparatus will maintain the power supply to the main system and prevents any loss of proceeding data.

As could be noted by one skilled in the art, the preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

What is claimed is:

1. A safe power-off system used for an electrical system which comprises:
a main system;
a power supply apparatus for supplying power to said main system, capable of generating a power-off signal when the power is manually turned off; and
a power switch for controlling a power connection between said power supply apparatus and said main system
wherein said safe power-off system is used to receive said power-off signal and therefore generate a indication signal to facilitate said main system to perform a preparation program containing a system power-off preparation procedure, and then said safe power-off system can be triggered, as long as the performance of said system power-off preparation procedure is completed, so as to notify the power switch to cut off the power connection between said main system and said power supply apparatus.

2. A safe power-off system according to claim 1, wherein said electrical system is a computer.

3. A safe power-off system according to claim 1, wherein said system power-off preparation procedure further comprises a procedure of storing each data that is being proceeded by said main system to a storage device.

4. A safe power-off system according to claim 3, wherein said storage device can be one of a floppy disk drive, a hard disk, a compact disc-read only memory (CD-ROM) drive, a network disk drive attached to the Internet, or other buffer intermediates.

5. A safe power-off system according to claim 3, wherein said preparation program further contains a procedure to determine whether said main system has completed the system power-off preparation procedure or not.

6. A safe power-off system according to claim 1, wherein said preparation program further comprises a timer procedure to count time for power off.

7. A safe power-off system according to claim 6, wherein said preparation program further comprises a procedure to determine whether said timer procedure has reached a predetermined time for power off.

8. A safe power-off system according to claim 1, wherein said main system can send back a confirming signal, relied on complete of performing said power-off preparation procedure, to said safe power-off system thereby triggering said safe power-off system to control said power switch to cut off the power connection between said main system and said power supply apparatus.

9. A safe power-off method for controlling the power connection between a main system and a power supply apparatus, comprising:
receiving a power-off signal from said power supply apparatus;
generating a corresponding interrupt signal to said main system according to said power-off signal;
facilitating said main system to perform a preparation program according to said interrupt signal wherein said preparation program contains a system power-off preparation procedure which is necessary to be performed before the power off of the main system;
writing a register signal into a register to trigger a safe power-off apparatus when said main system completes the performance of said preparation procedure; and
cutting off the power connection between said main system and said power supply apparatus when said safe power-off apparatus is triggered.

10. A safe power-off method according to claim 9, wherein after said register signal is written into said register, said register signal can change the electrical potential of a special pin number of said register to trigger said safe power-off apparatus.

11. A safe power-off method according to claim 9, wherein said power-off preparation procedure further comprises a procedure of storing a data that is being proceeded by said main system to a storage device.

12. A safe power-off method according to claim 11, wherein said storage device can be one of a floppy disk drive, a hard disk, a compact disc-read only memory (CD-ROM) drive, a network disk drive attached to the Internet, or other buffer intermediates.

13. A safe power-off method according to claim 11, wherein said preparation program further contains a procedure to determine whether said main system has completed said system power-off preparation procedure or not.

14. A safe power-off method according to claim 9, wherein said preparation program further contains a timer procedure to count time for power off.

15. A safe power-off method according to claim 14, wherein said preparation program further contains a procedure to determine whether said timer procedure has reached a predetermined time for power off.

16. A safe power-off method for controlling the power connection between a main system and a power supply apparatus, comprising:
receiving a power-off signal from said power supply apparatus;
generating a corresponding interrupt signal to said main system according said power-off signal;
facilitating said main system to perform a preparation program according to said interrupt signal wherein said preparation program contains a procedure to count a specified shutdown time;
writing a register signal into a register to trigger a safe power-off apparatus when said predetermined shutdown time is reached in count; and
cutting off the power connection between said main system and said power supply apparatus when said safe power-off apparatus is triggered.

17. A safe power-off method according to claim 16, wherein said preparation program further contains a timer procedure to determine whether said counted time has reached a predetermined shutdown time.

18. A safe power-off system used for an electrical system having a main system, a power supply apparatus for supplying power to said main system and a power switch for controlling a power connection between said power supply apparatus and said main system, said safe power-off system comprising:
a safe power-off apparatus capable of controlling said power switch to cut off the power connection between said main system and said power supply apparatus;
an interrupt controller capable of generating a corresponding interrupt signal to said main system when said safe power-off apparatus receives a power-off signal from said power supply apparatus;
a preparation program containing a system power-off preparation procedure which is necessary to be performed before power off of said main system; and
a memory mapping register capable of receiving a register signal generated by said preparation program, as long as said main system completes the performance for said system power-off preparation procedure, thereby triggering the safe power-off apparatus to control said power switch to cut off the power connection between said main system and said power supply apparatus.

19. A safe power-off system according to claim 18, wherein said preparation program further comprises a procedure to determine whether said main system has completed the performance for said system power-off preparation procedure.

20. A safe power-off system according to claim 18, wherein said preparation program further comprises a timer procedure to determine whether a predetermined shutdown time has been reached in count.
